(19) United States
(12) Patent Application Publication
(10) Pub. No.: US 2019/0301582 A1
(43) Pub. Date: Oct. 3, 2019

(54) DRIVE FORCE DISTRIBUTION APPARATUS

(71) Applicant: JTEKT CORPORATION, Osaka-shi (JP)

(72) Inventors: Yuji Tsuzuki, Chiryu-shi (JP); Mikiharu Oyabu, Chiryu-shi (JP); Ryouichi Kubo, Kashihara-shi (JP); Naoki Ootawara, Kariya-shi (JP); Hiroyuki Inoue, Anjo-shi (JP); Shun Ohno, Anjo-shi (JP)

(73) Assignee: JTEKT CORPORATION, Osaka-shi (JP)

(21) Appl. No.: 16/367,481

(22) Filed: Mar. 28, 2019

(30) Foreign Application Priority Data
Mar. 30, 2018 (JP) 2018-068771

(51) Int. Cl. F16H 48/19; F16D 13/52; F16D 21/06; F16D 13/74

(52) U.S. Cl. CPC F16H 48/19; F16D 13/74; F16D 21/06; F16D 13/52

(57) ABSTRACT

A drive force distribution apparatus includes a hollow shaft that rotates as a unit with a ring gear, a tubular clutch housing that is not allowed to rotate relative to the hollow shaft, a first multi-plate clutch located between the clutch housing and a first clutch hub, a second multi-plate clutch located between the clutch housing and a second clutch hub, and a stopper ring that keeps the clutch housing from coming off the hollow shaft. The stopper ring threadedly engages with a screw hole that is formed in the hollow shaft. An outer engagement portion of the hollow shaft engages with an inner engagement portion of the clutch housing. At least part of the outer engagement portion is located in the outer circumference of the screw hole.

### INCORPORATION BY REFERENCE

The disclosure of Japanese Patent Application No. 2018-068771 filed on Mar. 30, 2018 including the specification, drawings and abstract, is incorporated herein by reference in its entirety.

### BACKGROUND OF THE INVENTION

### 1. Field of the Invention

The invention relates to a drive force distribution apparatus that distributes drive force input from a drive source to multiple rotating output members.

### 2. Description of Related Art

Drive force distribution apparatuses that distribute drive force input from a drive source to multiple rotating output members are used as vehicle differentials. Japanese Patent Application Publication No. 2006-182242 (JP 2006-182242 A) describes a vehicle differential that includes multi-plate clutches having multiple clutch plates to adjust drive force to be transmitted to rotating output members.

In the drive force distribution apparatus (a rear-wheel-axle differential mechanism) disclosed in JP 2006-182242 A, drive force input to an input shaft is transmitted through a pair of bevel gears to a hollow shaft (a supporting member) and is then transmitted from the shaft to a tubular clutch housing (a clutch guide). The shaft and the clutch housing are splined together so that they are not allowed to rotate relative to each other. Inside the clutch housing, right and left output members are coaxially aligned with each other, a right multi-plate clutch having multiple right input plates and multiple right output plates is located between the clutch housing and the right output member, and a left multi-plate clutch having multiple left input plates and multiple left output plates is located between the clutch housing and the left output member. Further, a center plate is located between the right multi-plate clutch and the left multi-plate clutch.

JP 2006-182242 A describes a first embodiment where the center plate is axially slidable along spline grooves formed in the inner circumferential surface of the clutch housing, and a second embodiment where the center plate is fixed to the clutch housing by a fixation member. According to the first embodiment, both the right and left multi-plate clutches are pressed by equal hydraulic pressure supplied from a common hydraulic pressure feeder so that equal drive force is transmitted to both the right and left output members. According to the second embodiment, each of the right and left multi-plate clutches is pressed by hydraulic pressure supplied from a different hydraulic pressure feeder so that drive force based on the hydraulic pressure is transmitted individually to each of the right and left output members. JP 2006-182242 A describes that the second embodiment enables independent control of rotational drive force to be transmitted to right and left rear wheel axle shafts.

In such a drive force distribution apparatus, the axial position of a clutch housing needs to be fixed when independent control of rotational drive force to be transmitted to right and left wheel axle shafts is performed in the same manner as described in the second embodiment. This is because if the axial position of the clutch housing is not fixed, the force pressing the right multi-plate clutch also acts on the left multi-plate clutch, and the force pressing the left multi-plate clutch also acts on the right multi-plate clutch. Multiple bearings may be used to fix the axial position of the clutch housing. However, the use of bearings increases the number of parts in the apparatus and accordingly increases the cost and size of the apparatus. Further, depending on how the bearings are arranged, the bearings may block a path for supplying lubricating oil to the multi-plate clutches. If the path is blocked, wear and heat generation on the multi-plate clutches may be accelerated.

### SUMMARY OF THE INVENTION

A purpose of the invention is to provide a drive force distribution apparatus that allows fixation of an axial position of a clutch housing, while curbing an increase in the number of parts in the drive force distribution apparatus, so as to allow independent control of drive force to be transmitted to each of multiple rotating output members. Another purpose of the invention is to provide a drive force distribution apparatus that allows a sufficient supply of lubricating oil to a multi-plate clutch.

An aspect of the invention provides a drive force distribution apparatus that distributes drive force input from a drive source to first and second rotating output members and that includes the following: a case member having lubricating oil sealed in the case member; a ring gear that rotates about a rotation axis inside the case member by receiving the drive force; a shaft that is bearing-supported to the case member and that rotates as a unit with the ring gear; a tubular clutch housing that is not allowed to rotate relative to the shaft; a first multi-plate clutch having multiple first clutch plates and located between the clutch housing and the first rotating output member; a second multi-plate clutch having multiple second clutch plates and located between the clutch housing and the second rotating output member; a partition wall that is not allowed to axially move relative to the clutch housing and that is located between the first multi-plate clutch and the second multi-plate clutch; and a stopper member that keeps the clutch housing from coming off the shaft. The clutch housing includes a large-diameter cylindrical portion and a small-diameter cylindrical portion that is smaller in diameter than the large-diameter cylindrical portion. The large-diameter cylindrical portion houses the first and second multi-plate clutches. The small-diameter cylindrical portion has an inner circumferential surface provided with an inner engagement portion. The shaft has an outer circumferential surface provided with an outer engagement portion that engages with the inner engagement portion in a manner that does not allow relative rotation between the clutch housing and the shaft. The stopper member has an external thread portion and an opposed wall portion. The external thread portion threadedly engages with a screw hole that is formed in the shaft and that has an opening in an axial end face of the shaft. The opposed wall portion projects radially outward beyond the outer circumferential surface of the shaft and axially faces the small-diameter cylindrical portion of the clutch housing. At least part of the outer engagement portion of the shaft is located in the outer circumference of the screw hole.

The drive force distribution apparatus according to the aspect may be structured as follows: the shaft is hollow cylindrical in shape and includes a hollow portion in a center of the shaft and having the screw hole; the shaft has a through hole that extends through the outer circumferential surface and an inner circumferential surface of the shaft and that is located closer to the ring gear than the screw hole; the first multi-plate clutch is located closer to the ring gear than the second multi-plate clutch; and the lubricating oil flows through the through hole from the inner circumferential surface to the outer circumferential surface of the shaft and is supplied through a clearance between the small-diameter cylindrical portion of the clutch housing and the shaft to at least the first multi-plate clutch out of the first and second multi-plate clutches.

This aspect allows fixation of an axial position of the clutch housing, while curbing an increase in the number of parts in the drive force distribution apparatus, so as to allow independent control of the drive force to be transmitted to each of the rotating output members. Further, this allows the multi-plate clutch to be supplied with a sufficient amount of lubricating oil, thus reducing wear and heat generation on the multi-plate clutch.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a diagram schematically illustrating an example structure of a four-wheel drive vehicle equipped with a drive force distribution apparatus according to an embodiment of the invention;

FIG. 2 is a horizontal cross-sectional view of the whole of the drive force distribution apparatus mounted on the vehicle;

FIG. 3 is a vertical cross-sectional view of part of the drive force distribution apparatus mounted on the vehicle;

FIG. 4 is a cross-sectional view of a main portion of the drive force distribution apparatus;

FIG. 5A is a cross-sectional view taken along line A-A in FIG. 4 and illustrates a hollow shaft and a first clutch hub;

FIG. 5B is a cross-sectional view taken along line B-B in FIG. 4 and illustrates the hollow shaft, a clutch housing, and the first clutch hub; and

FIG. 5C is a cross-sectional view taken along line C-C in FIG. 4 and illustrates the first clutch hub and an axial end of a stopper ring.

### DETAILED DESCRIPTION OF EMBODIMENTS

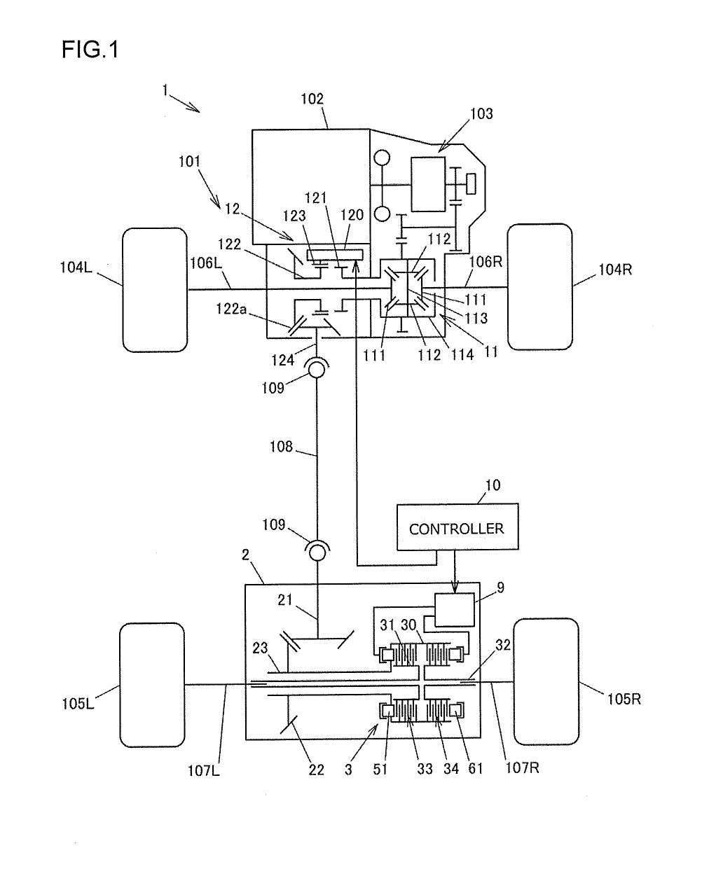

An embodiment of the invention is described with reference to FIGS. 1 to 5. FIG. 1 is a diagram schematically illustrating an example structure of a four-wheel drive vehicle 1 equipped with a drive force distribution apparatus 2 according to the embodiment.

The four-wheel drive vehicle 1 includes the following: an engine 102 as a drive source for generating drive force that the four-wheel drive vehicle 1 uses to travel; a transmission 103; right and left front wheels 104R and 104L as a pair of main drive wheels; right and left rear wheels 105R and 105L as a pair of auxiliary drive wheels; a drive force transmission system 101 that allows transmission of the drive force of the engine 102 to the front wheels 104R and 104L and to the rear wheels 105R and 105L; and a controller 10.

The four-wheel drive vehicle 1 is switchable between a four-wheel drive state and a two-wheel drive state. In the four-wheel drive state, the drive force of the engine 102 is transmitted to not only the front wheels 104R and 104L, but also the rear wheels 105R and 105L. In the two-wheel drive state, the drive force of the engine 102 is transmitted to only the front wheels 104R and 104L. Throughout the embodiment, the notations “R” and “L” in reference numerals are respectively used to denote the right side and the left side of the four-wheel drive vehicle 1.

The drive force transmission system 101 includes the following: a front differential 11; a propeller shaft 108 that serves as a drive shaft for transmitting the drive force of the engine 102 in a vehicle longitudinal direction; a dog clutch 12 that selectively interrupts the transmission of the drive force from the engine 102 to the propeller shaft 108; the drive force distribution apparatus 2 that variably distributes the drive force from the propeller shaft 108 to the rear wheels 105R and 105L; front drive shafts 106R and 106L; and rear drive shafts 107R and 107L. The drive force of the engine 102 is always transmitted to the front wheels 104R and 104L through the front drive shafts 106R and 106L. The drive force of the engine 102 is selectively transmitted to the rear wheels 105R and 105L through the dog clutch 12, the propeller shaft 108, the drive force distribution apparatus 2, and the rear drive shafts 107R and 107L.

The controller 10 controls the dog clutch 12 and the drive force distribution apparatus 2. When the four-wheel drive vehicle 1 is in the four-wheel drive state, the controller 10 causes the dog clutch 12 and the drive force distribution apparatus 2 to transmit the drive force to the rear wheels 105R and 105L. When the four-wheel drive vehicle 1 is in the two-wheel drive state, the controller 10 causes the dog clutch 12 and the drive force distribution apparatus 2 to interrupt the transmission of the drive force. Thus, in the two-wheel drive state, the propeller shaft 108 and other related elements stop rotating, so that fuel economy performance is improved accordingly.

The front differential 11 includes the following: a pair of side gears 111 each coupled to a corresponding one of the front drive shafts 106R and 106L; a pair of pinion gears 112 that mesh with the pair of side gears 111 with their gear axes perpendicular to each other; a pinion gear shaft 113 that supports the pair of pinion gears 112; and a front differential case 114 that houses the pair of side gears 111, the pair of pinion gears 112, and the pinion gear shaft 113. The drive force of the engine 102 is changed in speed by the transmission 103 and is then transmitted to the front differential case 114.

The dog clutch 12 includes the following: a first rotating member 121 that rotates as a unit with the front differential case 114; a second rotating member 122 coaxially aligned with the first rotating member 121; a sleeve 123 that selectively couples the first rotating member 121 and the second rotating member 122 together in a manner that does not allow relative rotation between the first rotating member 121 and the second rotating member 122; and an actuator 120 that is controlled by the controller 10. The sleeve 123 is moved by the actuator 120 between two positions: a coupling position where the sleeve 123 meshes with both the first rotating member 121 and the second rotating member 122; and a decoupling position where the sleeve 123 meshes with only the second rotating member 122. When the sleeve 123 is in the coupling position, the first rotating member 121 and the second rotating member 122 are coupled together in a manner that does not allow relative rotation between the first rotating member 121 and the second rotating member 122. When the sleeve 123 is in the decoupling position, the first rotating member 121 and the second rotating member 122 are allowed to rotate relative to each other.

The propeller shaft 108 receives the drive force of the engine 102 from the front differential case 114 through the dog clutch 12 and then transmits the drive force to the drive force distribution apparatus 2. One universal joint 109 is attached to each end of the propeller shaft 108. One of the universal joints 109 that is attached to the front end of the propeller shaft 108 in the vehicle longitudinal direction couples the propeller shaft 108 to a pinion gear shaft 124 that meshes with a ring gear portion 122a provided on the second rotating member 122 of the dog clutch 12. The other of the universal joints 109 that is attached to the rear end of the propeller shaft 108 in the vehicle longitudinal direction couples the propeller shaft 108 to a pinion gear shaft 21 of the drive force distribution apparatus 2.

The drive force distribution apparatus 2 includes the following: the pinion gear shaft 21 as a rotating input member; a ring gear 22 that rotates in mesh with the pinion gear shaft 21; a hollow shaft 23 that has a cylindrical hollow shape and that rotates as a unit with the ring gear 22; a clutch mechanism 3 that selectively transmits the drive force transmitted to the hollow shaft 23 to the rear drive shafts 107R and 107L; and a hydraulic unit 9 that supplies hydraulic oil to the clutch mechanism 3. The clutch mechanism 3 includes the following: a clutch housing 30 that rotates as a unit with the hollow shaft 23; and first and second clutch hubs 31 and 32 as first and second rotating output members. The clutch mechanism 3 distributes the drive force input from the pinion gear shaft 21 to the first and second clutch hubs 31 and 32, thereby outputting the drive force to the rear drive shafts 107R and 107L.

In the four-wheel drive state, the controller 10 controls the drive force distribution apparatus 2 such that more drive force is transmitted to the rear wheels 105R and 105L, for example, as a differential rotational speed increases and as an accelerator pedal depression amount increases. The differential rotational speed is the difference between the average rotational speed of the front wheels 104R and 104L and the average rotational speed of the rear wheels 105R and 105L. The accelerator pedal depression amount is the amount by which a driver depresses an accelerator pedal. Further, for example, when the four-wheel drive vehicle 1 makes a turn, the controller 10 transmits more drive force to the outer one of the rear wheels 105R and 105L in the direction of the turn being made than to the inner one in order to allow the four-wheel drive vehicle 1 to turn smoothly. As another example, when oversteer or understeer occurs, the controller 10 performs stability control that stabilizes vehicle traveling conditions by adjusting the drive force to be transmitted to each of the rear wheels 105R and 105L.

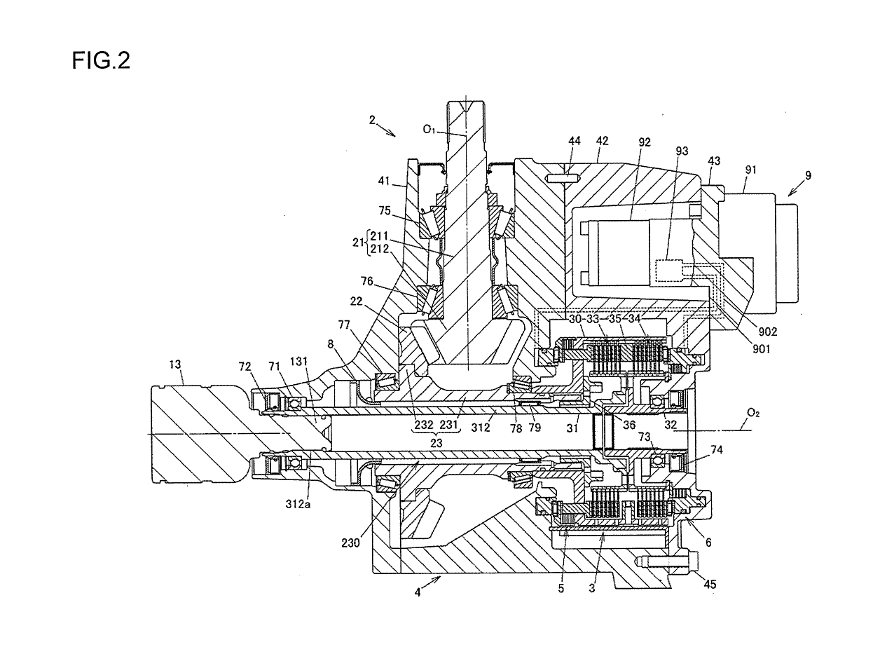

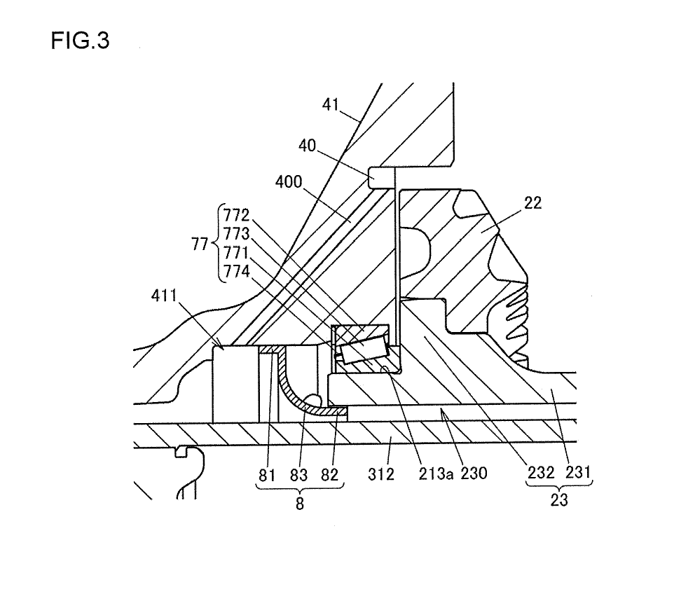

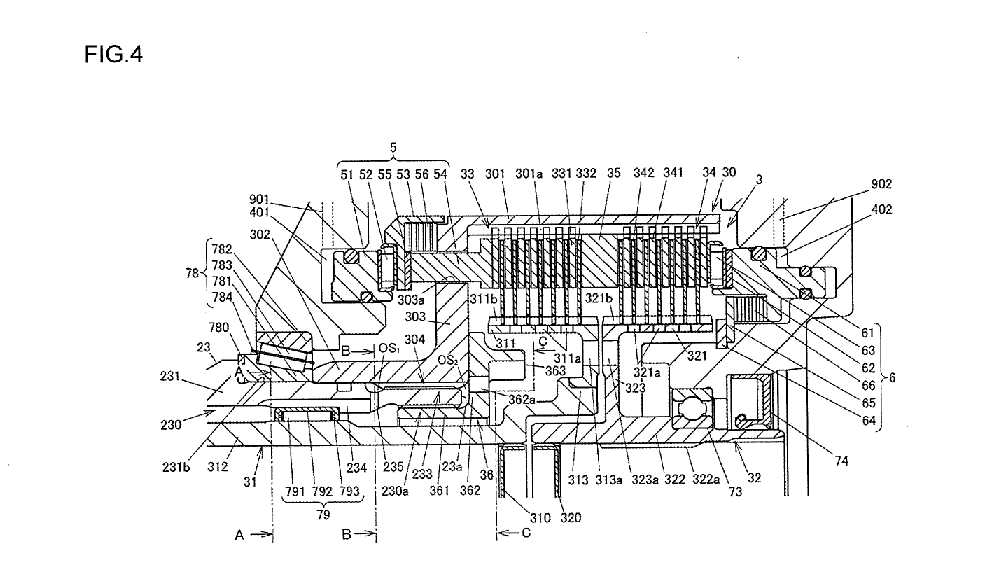

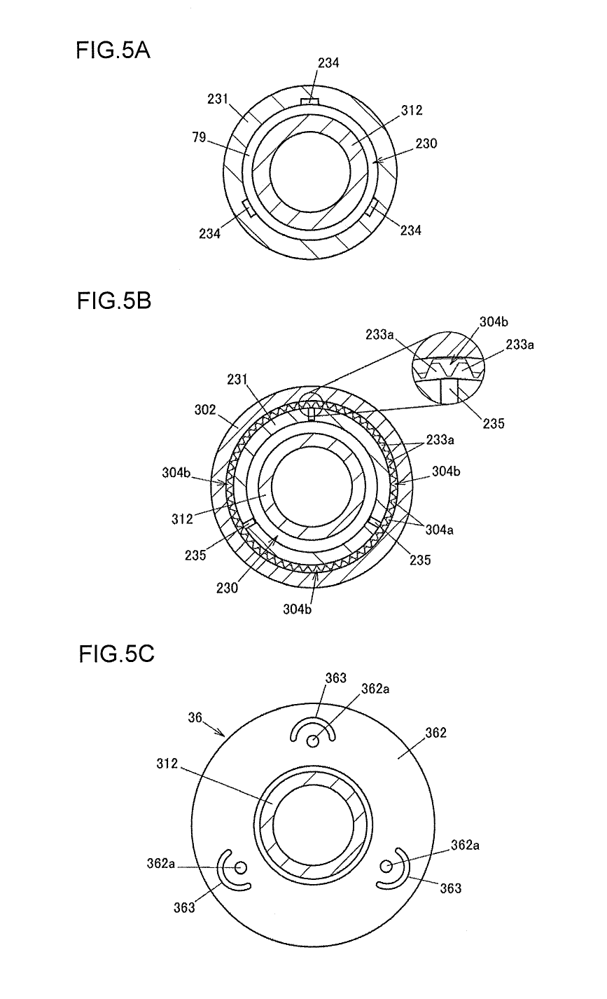

Next, the structure of the drive force distribution apparatus 2 is described in detail with reference to FIGS. 2 to 5. FIG. 2 is a horizontal cross-sectional view of the drive force distribution apparatus 2 mounted on the four-wheel drive vehicle 1. FIG. 3 is a vertical cross-sectional view of the drive force distribution apparatus 2 mounted on the four-wheel drive vehicle 1. FIG. 4 is a cross-sectional view of a main portion of the drive force distribution apparatus 2. FIG. 5A is a cross-sectional view taken along line A-A in FIG. 4 and illustrates the hollow shaft 23 and the first clutch hub 31. FIG. 5B is a cross-sectional view taken along line B-B in FIG. 4 and illustrates the hollow shaft 23, the clutch housing 30, and the first clutch hub 31. FIG. 5C is a cross-sectional view taken along line C-C in FIG. 4 and illustrates the first clutch hub 31 and an axial end of a later-described stopper ring 36. An upper side of FIG. 3 corresponds to a vertical upper side of the drive force distribution apparatus 2 mounted on the four-wheel drive vehicle 1.

The drive force distribution apparatus 2 has a case member 4 fixed to a body of the four-wheel drive vehicle 1. The pinion gear shaft 21, the ring gear 22, the hollow shaft 23, and the clutch mechanism 3 are located in the case member 4. The case member 4 includes a case body 41, a case lid 42, and a support body 43 that supports the hydraulic unit 9. The case body 41 and the case lid 42 are coupled together by multiple positioning pins 44 and bolts 45. FIG. 2 illustrates one of the positioning pins 44 and one of the positioning bolts 45. Lubricating oil (not illustrated) is sealed in the case member 4.

The clutch mechanism 3 includes the following: the clutch housing 30 that is tubular in shape and is not allowed to rotate relative to the hollow shaft 23; the first clutch hub 31 as a first rotating output member; the second clutch hub 32 as a second rotating output member; a first multi-plate clutch 33 located between the clutch housing 30 and the first clutch hub 31; a second multi-plate clutch 34 located between the clutch housing 30 and the second clutch hub 32; a partition wall 35 interposed between the first multi-plate clutch 33 and the second multi-plate clutch 34; and a stopper ring 36 that serves as a stopper member to keep the clutch housing 30 from coming off the hollow shaft 23.

As illustrated in FIG. 4, the clutch housing 30 unitarily includes the following: a large-diameter cylindrical portion 301 that houses the first and second multi-plate clutches 33 and 34; a small-diameter cylindrical portion 302 that is smaller in diameter than the large-diameter cylindrical portion 301; and a side wall portion 303 that connects the large-diameter cylindrical portion 301 and the small-diameter cylindrical portion 302. Multiple insertion holes 303a are formed in the side wall portion 303. The first multi-plate clutch 33 includes multiple first outer clutch plates 331 and multiple first inner clutch plates 332 that alternate with the first outer clutch plates 331. The second multi-plate clutch 34 includes multiple second outer clutch plates 341 and multiple second inner clutch plates 342 that alternate with the second outer clutch plates 341. The partition wall 35 is fixed, for example, welded to an inner surface of the large-diameter cylindrical portion 301 of the clutch housing 30 and is thus not allowed to axially move relative to the clutch housing 30.

The first clutch hub 31 includes the following: an outer cylindrical portion 311 radially facing the large-diameter cylindrical portion 301 of the clutch housing 30; an inner cylindrical portion 312 having an inner circumferential surface provided with a spline-fit portion 312a that fits on one end of the drive shaft 107L in a manner that does not allow relative rotation between the inner cylindrical portion 312 and the drive shaft 107L; and an end wall portion 313 located between respective ends of the outer cylindrical portion 311 and the inner cylindrical portion 312. FIG. 2 illustrates an outer race 13 of a constant-velocity joint that is part of the drive shaft 107L. A stem portion 131 of the outer race 13 fits in the spline-fit portion 312a.

The second clutch hub 32 includes the following: an outer cylindrical portion 321 radially facing the large-diameter cylindrical portion 301 of the clutch housing 30; an inner cylindrical portion 322 having an inner circumferential surface provided with a spline-fit portion 322a that fits on one end of the drive shaft 107R in a manner that does not allow relative rotation between the inner cylindrical portion 322 and the drive shaft 107R; and an end wall portion 323 located between respective ends of the outer cylindrical portion 321 and the inner cylindrical portion 322.

According to the embodiment, the first clutch hub 31 includes two members, and the two members are integrated together into the first clutch hub 31 by being welded to the end wall portion 313. Alternatively, the first clutch hub 31 may have a unitary structure formed from one member. According to the embodiment, the second clutch hub 32 has a unitary structure formed from one member. Alternatively, the second clutch hub 32 may include multiple members that are integrated together into the second clutch hub 32 by welding or any other suitable method.

An end cap 310 is attached to the inner cylindrical portion 312 of the first clutch hub 31 to prevent leakage of the lubricating oil. An end cap 320 is attached to the inner cylindrical portion 322 of the second clutch hub 32 to prevent leakage of the lubricating oil. A ball bearing 71 and a sealing member 72 are located between an outer circumferential surface of the inner cylindrical portion 312 of the first clutch hub 31 and an inner surface of an opening of the case body 41. A ball bearing 73 and a sealing member 74 are located between an outer circumferential surface of the inner cylindrical portion 322 of the second clutch hub 32 and an inner surface of an opening of the case lid 42.

The outer cylindrical portion 311 of the first clutch hub 31 has multiple oil holes 311a formed therein for circulating the lubricating oil. The outer cylindrical portion 321 of the second clutch hub 32 has multiple oil holes 321a formed therein for circulating the lubricating oil. The end wall portion 313 of the first clutch hub 31 has multiple oil holes 313a formed therein for circulating the lubricating oil. The end wall portion 323 of the second clutch hub 32 has multiple oil holes 323a formed therein for circulating the lubricating oil.

An inner circumferential surface of the large-diameter cylindrical portion 301 of the clutch housing 30 has multiple engaging projections 301a that engage with the first outer clutch plates 331 and the second outer clutch plates 341 in a manner that does not allow rotation of the first outer clutch plates 331 and the second outer clutch plates 341 relative to the large-diameter cylindrical portion 301.

An outer circumferential surface of the outer cylindrical portion 311 of the first clutch hub 31 has multiple engaging projections 311b that engage with the first inner clutch plates 332 in a manner that does not allow rotation of the first inner clutch plates 332 relative to the first clutch hub 31. An outer circumferential surface of the outer cylindrical portion 321 of the second clutch hub 32 has multiple engaging projections 321b that engage with the second inner clutch plates 342 in a manner that does not allow rotation of the second inner clutch plates 342 relative to the second clutch hub 32.

The first multi-plate clutch 33 transmits the drive force between the clutch housing 30 and the first clutch hub 31 by frictional force generated between the first outer clutch plates 331 and the first inner clutch plates 332. The second multi-plate clutch 34 transmits the drive force between the clutch housing 30 and the second clutch hub 32 by frictional force generated between the second outer clutch plates 341 and the second inner clutch plates 342.

The drive force distribution apparatus 2 further includes a first pressing mechanism 5 and a second pressing mechanism 6. The first pressing mechanism 5 presses the first multi-plate clutch 33 against the partition wall 35, thereby frictionally contacting the first outer clutch plates 331 and the first inner clutch plates 332 with each other. The second pressing mechanism 6 presses the second multi-plate clutch 34 against the partition wall 35, thereby frictionally contacting the second outer clutch plates 341 and second inner clutch plates 342 with each other. As already described, the partition wall 35 is not allowed to axially move relative to the clutch housing 30. Thus, the pressing force of the first pressing mechanism 5 is not applied to the second multi-plate clutch 34, and the pressing force of the second pressing mechanism 6 is not applied to the first multi-plate clutch 33.

The first pressing mechanism 5 includes the following: a first piston 51 for receiving hydraulic pressure that is supplied from the hydraulic unit 9 to a first cylinder 401 through a first oil passage 901; a thrust roller bearing 52 in abutment with the first piston 51; an annular pressure receiver 53 that is located relative to the first piston 51 such that the thrust roller bearing 52 is sandwiched between the first piston 51 and the pressure receiver 53; multiple pressing members 54 inserted through the insertion holes 303a in the side wall portion 303 of the clutch housing 30; a thrust washer 55 interposed between the pressure receiver 53 and the pressing members 54; and a return spring 56 located and compressed between the side wall portion 303 of the clutch housing 30 and the pressure receiver 53.

The second pressing mechanism 6 includes the following: a second piston 61 for receiving hydraulic pressure that is supplied from the hydraulic unit 9 to a second cylinder 402 through a second oil passage 902; a thrust washer 62 and a thrust roller bearing 63 that are located between the second piston 61 and the second multi-plate clutch 34; a snap ring 64 fitted to the case lid 42; a washer 65 in abutment with the snap ring 64; and a return spring 66 located and compressed between the washer 65 and the second piston 61.

The pinion gear shaft 21 has a shank 211 supported by a pair of tapered roller bearings 75 and 76, and a gear portion 212 provided at one end of the shank 211. The other end of the shank 211 is coupled to the universal joint 109 that is attached to the rear end of the propeller shaft 108. The pinion gear shaft 21 rotates about a rotation axis O₁ that extends in the vehicle longitudinal direction. The gear portion 212 of the pinion gear shaft 21 and the ring gear 22 in mesh with the gear portion 212 may be, for example, a hypoid gear set. The ring gear 22 rotates inside the case member 4 by receiving the drive force of the engine 102 transmitted from the pinion gear shaft 21.

The hollow shaft 23 unitarily has a cylindrical shank 231 and a flange 232 to which the ring gear 22 is attached. The hollow shaft 23 rotates as a unit with the ring gear 22 about a rotation axis O₂ that extends in a vehicle transverse direction. The flange 232 projects radially outward from the shank 231 and is fixed, for example, welded to the ring gear 22 to allow the hollow shaft 23 to rotate as a unit with the ring gear 22. The terms “axial” and “axially” used hereinafter refer to directions parallel to the rotation axis O₂.

The hollow shaft 23 has a hollow portion 230 in the center of the shank 231. The inner cylindrical portion 312 is inserted through the hollow portion 230. As already described, the inner cylindrical portion 312 is part of the first clutch hub 31. A helical screw groove is formed in an inner circumferential surface of one end of the hollow portion 230 so that the hollow portion 230 has a screw hole 230a at one end. As such, in the hollow shaft 23, the hollow portion 230 having the screw hole 230a is formed in the center of the shank 231 and axially penetrates the shank 231. The screw hole 230a has an opening in an axial end face 23a of the hollow shaft 23.

The hollow shaft 23 is supported inside the case member 4 by a pair of tapered roller bearings 77 and 78. An outer circumferential surface of the shank 231 of the hollow shaft 23 has bearing seats 231a and 231b. An inner ring 771 (refer to FIG. 3) of the tapered roller bearing 77 fits on the bearing seat 231a. An inner ring 781 of the tapered roller bearing 78 fits on the bearing seat 231b. The tapered roller bearing 77 includes the inner ring 771, an outer ring 772, multiple tapered rollers 773, and a cage 774 that holds the rollers 773. The tapered roller bearing 78 includes the inner ring 781, an outer ring 782, multiple tapered rollers 783, and a cage 784 that holds the rollers 783. The tapered roller bearings 77 and 78 are axially separated from each other across the flange 232. The tapered roller bearings 77 and 78 fix the axial position of the hollow shaft 23 relative to the case member 4 and support the hollow shaft 23 such that the hollow shaft 23 is allowed to rotate relative to the case member 4.

A radial roller bearing 79 is mounted between an inner circumferential surface of the hollow shaft 23 and the inner cylindrical portion 312 of the first clutch hub 31. The radial roller bearing 79 includes the following: multiple rollers 791 that roll on the outer circumferential surface of the inner cylindrical portion 312; an annular shell 792 that covers the outside of the rollers 791; and a cage 793 that holds the rollers 791. The radial roller bearing 79 is located closer to the ring gear 22 than the screw hole 230a. The radial roller bearing 79 suppresses radial oscillation of the first clutch hub 31 about a portion of the first clutch hub 31 that is supported by the ball bearing 71.

A funnel-shaped, lubricating-oil introduction member 8 is located radially outward from the inner cylindrical portion 312 of the first clutch hub 31. As illustrated in FIG. 3, the lubricating-oil introduction member 8 unitarily includes the following: a cylindrical base end 81 press-fitted in a fitting hole 411 that is formed in the case body 41; a cylindrical tip end 82 inserted in the hollow portion 230 of the hollow shaft 23; and an inclined portion 83 that decreases in diameter from the cylindrical base end 81 to the cylindrical tip end 82. An outer circumferential surface of the cylindrical tip end 82 faces an inner circumferential surface of the hollow portion 230 with a slight clearance therebetween. An inner circumferential surface of the cylindrical tip end 82 faces the outer circumferential surface of the inner cylindrical portion 312 of the first clutch hub 31 with a clearance therebetween that is greater than the clearance between the outer circumferential surface of the cylindrical tip end 82 and the inner circumferential surface of the hollow portion 230.

The outer circumferential surface of the shank 231 of the hollow shaft 23 is provided with an outer engagement portion 233. The outer engagement portion 233 is located at an end of the shank 231 that faces toward the clutch mechanism 3. The outer engagement portion 233 couples the hollow shaft 23 to the clutch housing 30 in a manner that does not allow relative rotation between the hollow shaft 23 and the clutch housing 30. An inner circumferential surface of the small-diameter cylindrical portion 302 of the clutch housing 30 is provided with an inner engagement portion 304 that circumferentially engages with the outer engagement portion 233. As illustrated in FIG. 5B, the outer engagement portion 233 includes multiple spline teeth 233a, and the inner engagement portion 304 includes multiple spline teeth 304a. The spline teeth 233a and 304a axially extend parallel to each other. The inner engagement portion 304 engages with the outer engagement portion 233 in a manner that does not allow relative rotation between the hollow shaft 23 and the clutch housing 30.

At least part of the outer engagement portion 233 is located in the outer circumference of the screw hole 230a. Specifically, the screw groove is formed in a partial area of the inner circumferential surface of the hollow portion 230 located radially inward from the outer engagement portion 233, and the area having the screw hole forms the screw hole 230a. According to the embodiment, an axial length of the outer engagement portion 233 from the axial end face 23a of the hollow shaft 23 is greater than an axial length of the screw hole 230a from the axial end face 23a. Alternatively, the axial length of the outer engagement portion 233 may be less than the axial length of the screw hole 230a.

The engagement between the inner engagement portion 304 and the outer engagement portion 233 does not restrict an axial movement of the clutch housing 30 relative to the hollow shaft 23. The stopper ring 36 keeps the clutch housing 30 from coming off the hollow shaft 23. Specifically, the small-diameter cylindrical portion 302 of the clutch housing 30 is clamped between the inner ring 781 of the tapered roller bearing 78 and the stopper ring 36 so that an axial position of the clutch housing 30 inside the case member 4 is fixed. An axial position of the inner ring 781 relative to the hollow shaft 23 is adjusted by a shim 780.

Alternatively, the inner ring 781 and the shim 780 may be interchanged in axial position so that an end of the small-diameter cylindrical portion 302 abuts with the shim 780. Alternatively, the hollow shaft 23 may be provided with a step portion having a diameter different from that of the remainder of the hollow shaft 23, and the end of the small-diameter cylindrical portion 302 may abut with the step portion. That is, it is only necessary that an abutment member or portion that the small-diameter cylindrical portion 302 axially abuts with by a clamping force applied by the stopper ring 36 and that applies a reaction force corresponding to the clamping force to the small-diameter cylindrical portion 302 is provided such that the abutment member or portion rotates as a unit with the hollow shaft 23.

The stopper ring 36 has the following: an external thread portion 361 threadedly engaging with the screw hole 230a of the hollow shaft 23; an opposed wall portion 362 that projects radially outward beyond the outer circumferential surface of the hollow shaft 23 and that axially faces the small-diameter cylindrical portion 302 and the side wall portion 303 of the clutch housing 30; and multiple canopy portions 363 having tip ends that are located radially inward of the first multi-plate clutch 33. The external thread portion 361 of the stopper ring 36 is screwed in the screw hole 230a to the extent that the opposed wall portion 362 abuts with the small-diameter cylindrical portion 302 and the side wall portion 303 of the clutch housing 30.

The hydraulic unit 9 includes the following: an electric motor 91 that generates torque corresponding to a motor current output from the controller 10; a hydraulic pump 92 that is driven by the electric motor 91; and a hydraulic circuit 93 that supplies hydraulic oil discharged from the hydraulic pump 92 to first and second oil passages 901 and 902. The hydraulic circuit 93 includes a control valve (not illustrated) that changes the degree of valve opening in accordance with a control current output from the controller 10. Each of the first and second oil passages 901 and 902 includes holes that are drilled in the case body 41, the case lid 42, and the support body 43.

The controller 10 outputs the motor current and the control current in such a manner as to supply the first and second oil passages 901 and 902 with hydraulic oil having a pressure appropriate for traveling conditions of the four-wheel drive vehicle 1. For example, when the four-wheel drive vehicle 1 turns left, the pressure of hydraulic oil supplied to the first oil passage 901 may be increased so that the drive force transmitted from the first multi-plate clutch 33 to the first clutch hub 31 is increased, and when the four-wheel drive vehicle 1 turns right, the pressure of hydraulic oil supplied to the second oil passage 902 may be increased so that the drive force transmitted from the second multi-plate clutch 34 to the second clutch hub 32 is increased. As another example, when a driver performs an operation that selects a four-wheel drive mode, the pressure of hydraulic oil supplied to each of the first and second oil passages 901 and 902 may be increased so that the four-wheel drive vehicle 1 is brought into the four-wheel drive state.

Next, a lubricating structure for supplying lubricating oil to the first and second multi-plate clutches 33 and 34 is described. Lubricating oil scooped up by rotation of the ring gear 22 is supplied to the first and second multi-plate clutches 33 and 34 through a path that is described later, thus lubricating frictional sliding between the first outer clutch plates 331 and the first inner clutch plates 332 and lubricating frictional sliding between the second outer clutch plates 341 and the second inner clutch plates 342.

Specifically, the rotation of the ring gear 22 inside the case member 4 scoops up lubricating oil stored in a lower portion of the case member 4, and part of the scooped lubricating oil is introduced into a catch tank 40 illustrated in FIG. 3. The lubricating oil introduced in the catch tank 40 flows down an oil passage 400 communicating with the catch tank 40 and is then supplied to the outer circumference of the inner cylindrical portion 312 of the first clutch hub 31 on the side of the drive shaft 107L with respect to the lubricating-oil introduction member 8 (i.e., on the opposite side of the lubricating-oil introduction member 8 from the ring gear 22).

Part of the lubricating oil supplied to the outer circumference of the inner cylindrical portion 312 of the first clutch hub 31 flows through the inside of the cylindrical tip end 82 of the lubricating-oil introduction member 8 into a space between the hollow shaft 23 and the inner cylindrical portion 312 of the first clutch hub 31. The lubricating-oil introduction member 8 limits backflow of the lubricating oil toward the drive shaft 107L from the space between the hollow shaft 23 and the inner cylindrical portion 312 of the first clutch hub 31.

Multiple oil grooves 234 are formed in the inner circumferential surface of the hollow portion 230 of the shank 231 of the hollow shaft 23. The oil grooves 234 face the radial roller bearing 79 and axially direct the lubricating oil toward the clutch mechanism 3. Although FIG. 5A illustrates that the shank 231 has three oil grooves 234 that are circumferentially equally spaced from each other, the number of the oil grooves 234 is not limited to three.

The hollow shaft 23 has multiple through holes 235 extending between the inner and outer circumferential surfaces of the shank 231. According to the embodiment, as illustrated in FIG. 5B, the shank 231 has three through holes 235 that are circumferentially equally spaced from each other, and each of the through holes 235 communicates with a corresponding one of the oil grooves 234. The through holes 235 are located axially closer to the ring gear 22 than the screw hole 230a, more specifically located axially between the radial roller bearing 79 and the screw hole 230a. In other words, the radial roller bearing 79 is located closer to the ring gear 22 than the through holes 235.

Centrifugal force caused by rotation of the hollow shaft 23 causes the lubricating oil in the through holes 235 to flow through the through holes 235 in a direction from the inner circumferential surface to the outer circumferential surface of the shank 231. Openings of the through holes 235 in the outer circumferential surface of the shank 231 are located closer to the ring gear 22 than the inner engagement portion 304 and the outer engagement portion 233. The lubricating oil that has passed through the through holes 235 flows between the small-diameter cylindrical portion 302 of the clutch housing 30 and the hollow shaft 23 and is then supplied to the first and second multi-plate clutches 33 and 34.

According to the embodiment, the inner engagement portion 304 of the clutch housing 30 has four missing tooth sections 304b. As illustrated in FIG. 5B, each of the missing tooth sections 304b has no spline teeth 304a so as to allow the lubricating oil to flow therethrough. Alternatively, such a missing tooth section may be formed in the outer engagement portion 233 of the hollow shaft 23 or may be formed in both the inner engagement portion 304 and the outer engagement portion 233. That is, the missing tooth section is formed in at least one of the inner engagement portion 304 and the outer engagement portion 233.

An annular first oil sump OS₁ that communicates with the through holes 235 and the missing tooth sections 304b is defined between the hollow shaft 23 and the small-diameter cylindrical portion 302 of the clutch housing 30. The lubricating oil that has passed through the through holes 235 flows through the first oil sump OS₁ into the missing tooth sections 304b. The first oil sump OS₁ enables smooth flow of the lubricating oil even when the through holes 235 are circumferentially displaced in position from the missing tooth sections 304b.

The opposed wall portion 362 of the stopper ring 36 has circulation holes 362a that axially penetrate the opposed wall portion 362 to circulate the lubricating oil that has passed between the small-diameter cylindrical portion 302 of the clutch housing 30 and the hollow shaft 23. In an example illustrated in FIG. 5C, the opposed wall portion 362 has three circulation holes 362a that are circumferentially equally spaced from each other. An annular second oil sump OS₂ that communicates with the missing tooth sections 304b and the circulation holes 362a in the opposed wall portion 362 of the stopper ring 36 is defined between the small-diameter cylindrical portion 302 of the clutch housing 30 and the opposed wall portion 362. The second oil sump OS₂ enables smooth flow of the lubricating oil even when the missing tooth sections 304b are circumferentially displaced in position from the circulation holes 362a.

The canopy portions 363 of the stopper ring 36 are located radially outward from openings of the circulation holes 362a in the opposite side of the opposed wall portion 362 from the hollow shaft 23. According to the embodiment, the stopper ring 36 has three canopy portions 363 that are each provided to a corresponding one of the three circulation holes 362a and that axially project from the opposed wall portion 362 toward a space between the outer cylindrical portion 311 and the inner cylindrical portion 312 of the first clutch hub 31. When the lubricating oil is splashed from the tip ends in the projecting direction of the canopy portions 363 under the centrifugal force, the splashed lubricating oil adheres to the inner circumferential surface of the outer cylindrical portion 311 and is then supplied to the first multi-plate clutch 33 through the oil holes 311a.

Further, part of the lubricating oil adhered to the inner circumferential surface of the outer cylindrical portion 311 is supplied to the second multi-plate clutch 34 through the oil holes 313a in the end wall portion 313 of the first clutch hub 31 and the oil holes 323a in the end wall portion 323 of the second clutch hub 32, or through a clearance between the end wall portions 313 and 323. Alternatively, the lubricating oil splashed from the canopy portions 363 of the stopper ring 36 may be supplied to only the first multi-plate clutch 33, and another structure may be provided to supply lubricating oil to the second multi-plate clutch 34. That is, the lubricating oil that has passed through the path described above is supplied to at least the first multi-plate clutch 33.

As described above, according to the embodiment, the inner circumferential surface of the small-diameter cylindrical portion 302 of the clutch housing 30 is provided with the inner engagement portion 304, the outer circumferential surface of the hollow shaft 23 is provided with the outer engagement portion 233 that engages with the inner engagement portion 304 in a manner that does not allow the relative rotation between the clutch housing 30 and the hollow shaft 23, and the stopper ring 36 keeps the clutch housing 30 from coming off the hollow shaft 23. Further, at least part of the outer engagement portion 233 of the hollow shaft 23 is located in the outer circumference of the screw hole 230a that the stopper ring 36 threadedly engages with. This structure allows fixation of the axial position of the clutch housing 30 inside the case member 4 while curbing an increase in the number of parts in the drive force distribution apparatus 2.

Further, according to the embodiment, the lubricating oil scooped up by rotation of the ring gear 22 is supplied to the first and second multi-plate clutches 33 and 34 through the above-described path that passes through the hollow portion 230 of the hollow shaft 23. Thus, the first and second multi-plate clutches 33 and 34 are supplied with a sufficient amount of lubricating oil to reduce wear and heat generation on the first and second multi-plate clutches 33 and 34.

The embodiment may be modified in various ways within the scope of the invention. For example, although the embodiment describes that the first and second multi-plate clutches 33 and 34 are pressed by the first and second pistons 51 and 61 that receive hydraulic pressures, any other suitable structure may be used, such as a cam mechanism that converts rotational force of an electric motor to axial cam thrust forces that press the first and second multi-plate clutches 33 and 34. The structure of the four-wheel drive vehicle 1 is not limited to the example illustrated in FIG. 1.

What is claimed is:

1. A drive force distribution apparatus that distributes drive force input from a drive source to first and second rotating output members, the drive force distribution apparatus comprising:
a case member having lubricating oil sealed in the case member;
a ring gear that rotates about a rotation axis inside the case member by receiving the drive force;
a shaft that is bearing-supported to the case member and that rotates as a unit with the ring gear;
a tubular clutch housing that is not allowed to rotate relative to the shaft;
a first multi-plate clutch having a plurality of first clutch plates and located between the clutch housing and the first rotating output member;
a second multi-plate clutch having a plurality of second clutch plates and located between the clutch housing and the second rotating output member;
a partition wall that is not allowed to axially move relative to the clutch housing and that is located between the first multi-plate clutch and the second multi-plate clutch; and
a stopper member that keeps the clutch housing from coming off the shaft, wherein
the clutch housing includes a large-diameter cylindrical portion and a small-diameter cylindrical portion that is smaller in diameter than the large-diameter cylindrical portion,
the large-diameter cylindrical portion houses the first and second multi-plate clutches,
the small-diameter cylindrical portion has an inner circumferential surface provided with an inner engagement portion,
the shaft has an outer circumferential surface provided with an outer engagement portion that engages with the inner engagement portion in a manner that does not allow relative rotation between the clutch housing and the shaft,
the stopper member has an external thread portion and an opposed wall portion,
the external thread portion threadedly engages with a screw hole that is formed in the shaft and that has an opening in an axial end face of the shaft,
the opposed wall portion projects radially outward beyond the outer circumferential surface of the shaft and axially faces the small-diameter cylindrical portion of the clutch housing, and
at least part of the outer engagement portion of the shaft is located in an outer circumference of the screw hole.

2. The drive force distribution apparatus according to claim 1, wherein
the shaft is hollow cylindrical in shape and includes a hollow portion in a center of the shaft and having the screw hole,
the shaft has a through hole that extends through the outer circumferential surface and an inner circumferential surface of the shaft and that is located closer to the ring gear than the screw hole,
the first multi-plate clutch is located closer to the ring gear than the second multi-plate clutch, and
the lubricating oil flows through the through hole from the inner circumferential surface to the outer circumferential surface of the shaft and is supplied through a clearance between the small-diameter cylindrical portion of the clutch housing and the shaft to at least the first multi-plate clutch out of the first and second multi-plate clutches.

3. The drive force distribution apparatus according to claim 2, wherein
the opposed wall portion of the stopper member has a circulation hole that axially penetrates the opposed wall portion to circulate the lubricating oil that has passed between the small-diameter cylindrical portion of the clutch housing and the shaft.

4. The drive force distribution apparatus according to claim 3, wherein
an annular oil sump that communicates with the circulation hole in the opposed wall portion of the stopper member is defined between the small-diameter cylindrical portion of the clutch housing and the opposed wall portion.

5. The drive force distribution apparatus according to claim 3, wherein
the stopper member has a canopy portion that is located radially outward from an opening of the circulation hole in an opposite side of the opposed wall portion from the shaft, and
a tip end of the canopy portion is located radially inward from the first multi-plate clutch.

6. The drive force distribution apparatus according to claim 2, wherein
each of the inner engagement portion and the outer engagement portion has a plurality of spline teeth that extend axially parallel to each other, and
at least one of the inner engagement portion and the outer engagement portion has a missing tooth section that allows the lubricating oil to flow through the missing tooth section.

7. The drive force distribution apparatus according to claim 2, wherein
part of the first rotating output member is inserted through the hollow portion of the shaft,
a bearing is located between the part of the first rotating output member that is closer to the ring gear than the through hole in the shaft and an inner circumferential surface of the hollow portion, and
the inner circumferential surface of the hollow portion that faces the bearing has a groove that directs the lubricating oil toward the through hole.
